(19) United States
(12) Patent Application Publication
(10) Pub. No.: US 2016/0208657 A1
(43) Pub. Date: Jul. 21, 2016

(54) OPERATING METHOD FOR STARTING A ONCE-THROUGH STEAM GENERATOR HEATED USING SOLAR THERMAL ENERGY

(71) Applicant: SIEMENS AKTIENGESELLSCHAFT, München (DE)

(72) Inventors: Jan Brückner, Uttenreuth (DE); Frank Thomas, Erlangen (DE)

(73) Assignee: SIEMENS AKTIENGESELLSCHAFT, Munich (DE)

(21) Appl. No.: 14/912,987

(22) PCT Filed: Aug. 20, 2014
(86) PCT No.: PCT/EP2014/067730

§ 371 Date: Feb. 19, 2016

(30) Foreign Application Priority Data
Aug. 28, 2013 (DE) 10 2013 217 156.0

(51) Int. Cl. F01K 13/02; F03G 6/06; F01K 7/16

(52) U.S. Cl. CPC F01K 13/02; F01K 7/165; F03G 6/06

(57) ABSTRACT

An operating method for starting a once-through steam generator heated using solar thermal energy, wherein a flow medium flowing through the once-through steam generator is evaporated and superheated, using a heat carrier medium heated in a solar array, for a steam turbine connected downstream of the once-through steam generator on the flow medium side. In an operating phase under load, a first desired steady pressure value is predetermined, and in a starting phase preceding the operating phase under load, a second desired steady pressure value is predetermined, in which starting phase evaporated flow medium is diverted around the steam turbine via a steam bypass, and controlled by the predetermined second desired steady pressure value.

### CROSS REFERENCE TO RELATED APPLICATIONS

This application is the US National Stage of International Application No. PCT/EP2014/067730 filed Aug. 20, 2014, and claims the benefit thereof. The International Application claims the benefit of German Application No. DE 102013217156.0 filed Aug. 28, 2013. All of the applications are incorporated by reference herein in their entirety.

### FIELD OF INVENTION

The invention relates to an operating method for starting a once-through steam generator heated using solar thermal energy.

### BACKGROUND OF INVENTION

Solar thermal power plants represent an alternative to conventional electricity generation. A power plant principle which is already known in this field is what is known as the parabolic trough power plant. In this type of power plant, use is typically made, as the heat transfer medium, of thermal oil, which flows through the parabolic troughs of a solar array and thus absorbs the heat introduced via the sun and transfers this heat to a flow medium flowing in pipes through the steam generator.

For such a steam generator heated using solar thermal energy, the once-through principle represents an advantageous embodiment. The flow medium entering the once-through steam generator, and also termed feed water at this point, is heated, evaporated and superheated in a single pass. The superheated flow medium is then fed, as fresh steam, via a water-steam separator to the steam turbine. The water-steam separator at the outlet of the once-through steam generator is then predominantly used during the start-up phase. During the normal load operation phase, by contrast, sufficiently superheated flow medium must always be present at the outlet of the once-through steam generator and thus also in the water-steam separator, in order that the steam turbine is not charged with saturated steam. Setting the corresponding fresh steam temperature at the outlet of the once-through steam generator can therefore be set with precision only by choosing the correct feed water mass flow; correspondingly fluctuations in the feed water mass flow are directly linked to fluctuations in the fresh steam temperature.

In order to counteract such fluctuations in the fresh steam temperature in the feed water-steam circuit, in particular during the load operation phase of solar thermal power plants, there has already been proposed, in WO 2012/110344 A1, a method for the predictive or anticipatory control of the feed water mass flow by means of a correction value. This type of predictive control of the feed water mass flow makes it possible to minimize deviations from the setpoint value in the specific enthalpy at the outlet of the once-through steam generator, and undesirably large fluctuations resulting therefrom in the fresh steam temperature in all operating states of the load operation, which are caused by transient states as for example in the event of a change in load.

However, such transient states do not arise only during the load operation phase but also already during the start-up phase of the once-through steam generator heated using solar thermal energy. It is thus possible, specifically here in the start-up phase, for substantial temperature changes with high temperature transients to arise at the outlet of the once-through steam generator. This is essentially due to the fact that, after the first absorption of heat by the heat transfer medium, first steam is produced which pushes downstream excess feed water, which has not yet been evaporated, out of the pipes (what is referred to as water ejection), which water must then be separated from the produced steam in the water-steam separator. This highly unsteady process of water ejection generally results in short-term decoupling of the fresh steam mass flow at the outlet of the once-through steam generator from the feed water mass flow at the inlet of the once-through steam generator. This effect is reinforced by the fact that, in this start-up phase brought about by the increasing solar irradiation, the temperature of the heat transfer medium flowing into the once-through steam generator is constantly increasing. Specifically in the start-up phase of once-through steam generators heated using solar thermal energy, it is thus possible for impermissibly high temperature transients to arise at the outlet of the once-through steam generator, which, in particular in the case of thick-walled components of the once-through steam generator, for example the outlet collectors, can, in the most unfavorable case, result in material failure. This is particularly disadvantageous specifically in the case of solar thermal power plants which must be started up daily in dependence on the solar irradiation.

### SUMMARY OF INVENTION

The invention therefore has the object of providing an operating method which can keep transient states within permissible limits during the daily start-up and thus in the start-up phase of the once-through steam generator heated using solar thermal energy.

This object is achieved with the method for starting up a once-through steam generator having the features of the independent claim.

By virtue of the fact that, for starting a once-through steam generator heated using solar thermal energy, in which a heat transfer medium heated in a solar array is used to evaporate and superheat a flow medium, flowing through the once-through steam generator, for a steam turbine connected downstream of the once-through steam generator as seen by the flow medium, and for a load operation phase a first fixed-pressure setpoint value is predefined, and, for a start-up phase preceding the load operation phase, a second fixed-pressure setpoint value of in particular approximately 50-70 bar is predefined, and in this start-up phase evaporated flow medium is diverted in a controlled manner via a steam bypass line around the steam turbine at the predefined second fixed-pressure setpoint value, it is possible to achieve a marked reduction in the temperature transients and thus a protective increase in the fresh steam temperature at the outlet of the once-through steam generator. The chosen pressure of approximately 50-70 bar for the second fixed-pressure setpoint value is here chosen such that the steam temperature necessary for activating the steam turbine and in particular the necessary steam superheating can furthermore be achieved as quickly as possible, such that no notable increase in the quantity of steam issuing via a high-pressure or low-pressure bypass line arises during the start-up phase.

The action of the present invention is thus based essentially on three causes:
Mass flow fluctuations of the flow medium at the outlet of the once-through steam generator, which arise to a greater extent specifically during start-up and here in particular during water ejection and accordingly in the temporal transition region from wet operation to superheated operation, lead directly to fluctuations in enthalpy at the outlet of the once-through steam generator. For physical reasons, however, at higher pressures such enthalpy fluctuations lead to smaller differences in the temperature of the superheated steam. Accordingly, during the first superheating phase it is possible, by raising the pressure, to markedly reduce the absolute temperature rise and thus consequently also the temperature transient.
Differences in density between the water phase and the steam phase decrease with increasing pressure. Thus, there is also less of an increase in the specific volume of the flow medium at the transition from saturated water to saturated steam at a relatively higher pressure. This can reduce the water ejection via the feed water-steam separator arranged at the outlet of the once-through steam generator heated using solar thermal energy. The steam generator pipes are less inclined to excessively push out feed water, which must be replaced by fresh feed water before it can then again leave as superheated steam at the outlet. Thus, the less of a decoupling that arises between the feed water mass flow and the fresh steam mass flow, the better this is for keeping to the temperature setpoint value predefined in a feed water control unit. This decoupling is increasingly prevented as the pressure rises.
For physical reasons, the flow medium in the once-through steam generator has a higher boiling point at higher pressures. This lowers, in the once-through steam generator, the temperature difference between the flow medium and the heat transfer medium flowing in from the solar array, which also has a positive effect on the temperature transients since, under these conditions, the temperature rise of the steam at the outlet of the once-through steam generator turns out to be smaller.

Advantageous developments can be found in the dependent claims. In particular in solar thermal power plants known at present, therefore, there is predefined for the start-up phase a fixed-pressure setpoint value which is almost twice as high as the fixed-pressure setpoint value of approximately 35 bar predefined for the subsequent load operation phase, such that the predefined second fixed-pressure setpoint value is greater than the first fixed-pressure setpoint value. If, by contrast, in the case of solar thermal power plants, use is made of steam turbines which are started up only at higher pressures, for example 60 bar (frequently in the case of steam turbines with integrated regulating wheel), the fixed pressure of the start-up phase already approximately corresponds to that of the load operation phase, such that a further increase in the fixed-pressure setpoint value is not necessary here.

### BRIEF DESCRIPTION OF THE DRAWINGS

FIG. 1 shows a once-through steam generator.

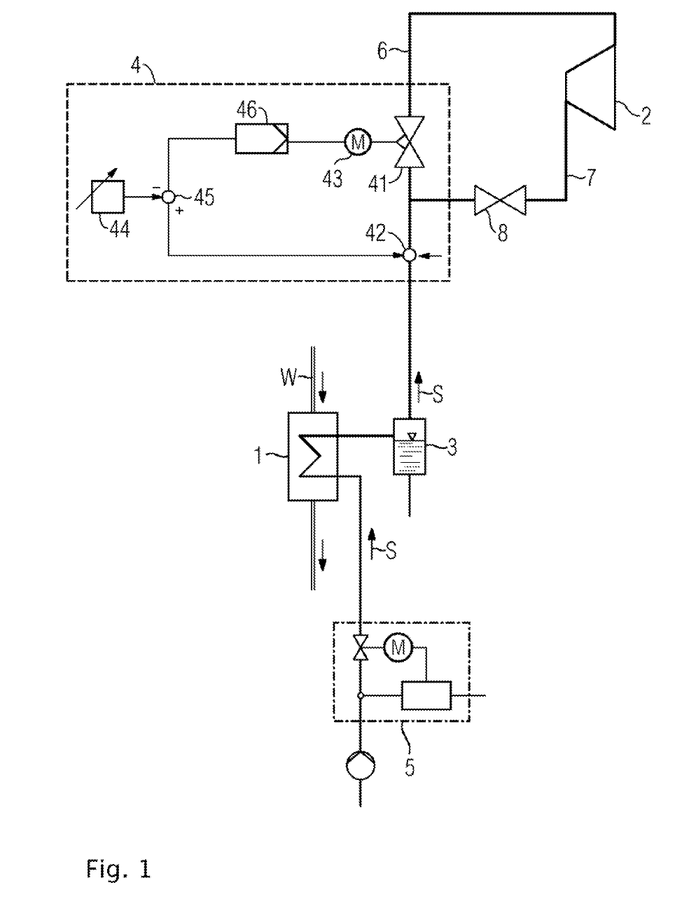

### DETAILED DESCRIPTION OF INVENTION

The invention will now be explained, by way of example, with reference to a FIGURE. The FIGURE shows a once-through steam generator 1. Here, a heat transfer medium W heated in a solar array (not shown in more detail) is used to evaporate a flow medium S, flowing through the once-through steam generator 1 in steam generator pipes, in that heat is transferred from the heat transfer medium W to the flow medium S flowing through the steam generator pipes. During normal load operation, the flow medium evaporated and superheated in the once-through steam generator 1 is then, during the load operation phase, fed to a steam turbine 2 via one or more steam lines 7 having one or also more valves 8. In dependence on the quantity of steam produced, the maximum flow rate of the steam turbine 2 establishes, in what is referred to as sliding-pressure operation, a corresponding fresh steam pressure at the outlet of the once-through steam generator 1. Now, if this fresh steam pressure drops with reduced steam production, there is a lower limit—dictated by the once-through steam generator 1—below which the fresh steam pressure should not drop further because of a number of fluid-dynamic effects of the flow medium in the once-through steam generator 1. This lower limit is usually termed fixed pressure level, fixed-pressure setpoint value or simply just fixed pressure. By virtue of a corresponding throttling of the valve 8, it is possible to effectively counter a further drop in the fresh steam pressure below the desired fixed-pressure setpoint value, in the event of a further reduction of steam production (for example as a consequence of reduced solar irradiation).

The mass flow rate of the flow medium S, also termed feed water, entering the once-through steam generator 1 is controlled by means of a control unit 5 during all operation, that is to say from start-up in the start-up phase to normal load operation in the load operation phase. For the start-up phase, there is also provided, at the outlet of the once-through steam generator heated using solar thermal energy, a water-steam separator 3 by means of which unevaporated water, which arises to a greater extent specifically during the start-up phase, can, at the outlet of the once-through steam generator 1, be separated from the produced steam and subsequently discharged.

In particular at the start of the start-up phase of the once-through steam generator 1, it is possible for the initially produced steam not to be immediately supplied to the steam turbine 2. The reason for this is essentially that the steam parameters required by the steam turbine 2 (in particular pressure, temperature and steam superheating) have not yet been reached. For that reason, the evaporated flow medium S has to be diverted around the steam turbine 2 via corresponding steam bypass lines 6. This bypassing usually takes place in a controlled manner by means of a corresponding control device 4. This encompasses, inter alia, a controllable valve 41 arranged in the steam bypass line 6 shown here, and a pressure measuring device 42 positioned upstream thereof as seen by the flow medium.

However, specifically during this bypass operation in the start-up phase, the fixed pressure must furthermore be reached as quickly as possible, which can be ensured by suitable control of the valve 41. This is precisely what the invention addresses. If, now, according to the invention, with presently known configurations of solar thermal power plants, the fixed-pressure setpoint value is increased during start-up from the value of 35 bar predefined for normal operation to approximately twice that value, 50-70 bar, it is then possible, at the outlet of the once-through steam generator 1, for the temperature transients to be kept within permissible limits with regard to the critical components (for example thick-walled collectors). A possible control structure 4 for the control valve 41, which would be suitable therefor, is shown in the figure. The second fixed-pressure setpoint value, valid for the start-up phase, is set by means of 44. The pressure measuring device 42 measures the pressure currently prevailing in the bypass line 6. Both values are then fed to a control unit 46 via 45 as a control deviation. This control unit 46 can for example be a PID, PI or P or a combination of the individual control units. The controller 45 then actuates the controllable valve 41, according to the control deviation, via a motor 43 or also any other actuating member, such that the mass flow of the flow medium S diverted via the steam bypass line 6 is set according to the second fixed-pressure setpoint value predefined for the start-up phase.

1. An operating method for starting a once-through steam generator heated using solar thermal energy, comprising:
using a heat transfer medium heated in a solar array to evaporate and superheat a flow medium, flowing through the once-through steam generator, for a steam turbine connected downstream of the once-through steam generator as seen by the flow medium,
wherein for a load operation phase a first fixed-pressure setpoint value is predefined, and
wherein, in a start-up phase preceding the load operation phase, a second fixed-pressure setpoint value is predefined and in this start-up phase evaporated flow medium is diverted in a controlled manner via a steam bypass line around the steam turbine at the predefined second fixed-pressure setpoint value.

2. The operating method as claimed in claim 1, further comprising:
setting a mass flow of the flow medium diverted via the steam bypass line by means of a control valve installed in the steam bypass line, wherein the predefined second fixed-pressure setpoint value is used to control this control valve.

3. The operating method as claimed in claim 1,
wherein the predefined second fixed-pressure setpoint value is in a range between 50 and 70 bar.

4. The operating method as claimed in claim 1,
wherein the predefined second fixed-pressure setpoint value is greater than the first fixed-pressure setpoint value.

5. The operating method as claimed in claim 1,
wherein the predefined second fixed-pressure setpoint value is approximately identical to the first fixed-pressure setpoint value.
